(19) United States
(12) Patent Application Publication
(10) Pub. No.: US 2017/0076061 A1
(43) Pub. Date: Mar. 16, 2017

(54) MONITORING SYSTEM FOR MEDICATION COMPLIANCE

(71) Applicants: Stephen Axelrod, Denver, CO (US); Ralph Beckman, Providence, RI (US)

(72) Inventors: Stephen Axelrod, Denver, CO (US); Ralph Beckman, Providence, RI (US)

(21) Appl. No.: 15/266,368

(22) Filed: Sep. 15, 2016

Related U.S. Application Data
(60) Provisional application No. 62/218,806, filed on Sep. 15, 2015.

(51) Int. Cl. G06F 19/00; G06K 9/20; G06K 9/00

(52) U.S. Cl. CPC G06F 19/3456; G06F 19/3418; G06K 9/00536; G06K 9/00288; G06K 9/209

(57) ABSTRACT

A method and system for monitoring compliance with medication regimens. The system is integrated onto the back or side of a medication dispensing package for monitoring and compliance tracking of medication regimens. The system includes a camera that is web enabled to upload photo and/or video content to a cloud based tracking database for analysis, tracking and further processing as desired. When a user approaches the medication box, the camera preferably captures an image of the pill package being dispensed and an image of the face of the person removing the pill package. This information is streamed to an algorithm/database housed in the cloud wherein the data is processed using predetermined rule sets. The rule sets may include a determination that the correct person took the medication via a facial recognition process, the time and day the medication was taken, the package dispense, etc.

### CROSS-REFERENCE TO RELATED APPLICATIONS

This application is related to and claims priority from earlier filed U.S. Provisional Patent Application No. 62/218,806, filed Sep. 15, 2015.

### BACKGROUND OF THE INVENTION

The present invention relates to a method and system for monitoring compliance with medication regimens. More specifically, the present invention relates to method and system for implementation with pre-packaged medication systems for the tracking and monitoring of when, where and by whom the medication was taken.

Advances in patient care have helped to dramatically increase patients' lifespans and quality of life through the development of more effective treatments, medications, and medical technologies. Despite these advances, a leading cause of hospitalizations and medical patient fatalities is accidental patient non-compliance with pharmaceutical dosage programs. For example, many patients often forget to take their medications, take too many doses of their medications, take the wrong medications, or take their medications in an incorrect manner. Additionally, keeping medications secure and safe from diversion is an increasingly challenging issue. As a result, taking medications in a non-compliant fashion often leads to a prolonging of disease-related symptoms, an increase in serious complications, unnecessary additional medical visits, higher medical costs, and possibly even death.

People often use the assistance of calendars, physicians, other people, their own memory, and other methods to help remind them to take a particular medication or to help verify that they took the medication according to the proper regimen. However, such methods often fail to adequately remind the patient to take their medications on a regular basis or in an effective manner. Such methods further fail to verify that the patient actually took the medication appropriately.

Despite the various tracking methods employed in the prior art, medication adherence is a significant, pervasive, and costly healthcare problem. The New England Healthcare Institute estimates that poor medication adherence, along with suboptimal prescribing, drug administration, and diagnosis, results in as much as $290 billion annually in avoidable medical spending. An estimated one-third to one-half of all patients in the U.S. does not take their medications as prescribed by their doctors. Such a lack of medication adherence results in $100 billion each year in excess hospitalizations alone.

It is also known that medication adherence disproportionately affects the elderly. A 2009 study found that almost 20% of the nearly 12 million Medicare beneficiaries discharged from a hospital each year were subsequently re-hospitalized within 30 days, and over one-third were re-hospitalized within 90 days. The single greatest cause of hospital readmissions are attributed to poor patient compliance with treatment regimens, especially medication adherence. Seniors are more likely to have both complex medication regimens and cognitive difficulty, each of which contributes to poor compliance. Incorrect medication consumption accounts for an estimated 25-40% of all Medicare hospital admissions. Especially as patients age, medication adherence can provide a burden on family members and other caregivers, who are often thrust into a difficult and unwelcome role of ensuring compliance. Sadly, the decision to move an independently living, elderly parent into a care facility is often driven by the need for assistance with a complicated medication program.

A number of medication adherence technologies have been expanding in both variety and sophistication. Patients have highly varied needs for medication adherence technologies. The following is a list of the types of available medication adherence devices:

Simple pill boxes: Simple medication organizers often designed for seven-day supplies.

Alerts: Telephonic, text, email reminders to take medication at the prescribed times.

Complex pill holders with alarms: Medication organizers that also have alarms or alerting for prescribed medication times

Automated Dispensers: An automated dispensing device both prompts the patients to take their medication and dispenses the medication to them.

Monitoring Devices: Monitoring devices provide automated tracking and reporting of a patient's medication regimen in addition to medication dispensing and reminders.

Medication monitoring can reveal whether a patient is taking a medication, or taking an appropriate dosage at the appropriate times. Monitoring information includes biometric data, administrative data (e.g., whether a prescription was filled), subjective reports, and health service utilization data. Inadequate monitoring is a natural target for quality improvement. According to a study of ambulatory Medicare beneficiaries, adverse drug events occurred at a rate of 50 per 1000 person-years, with a rate of 14 preventable adverse drug events (ADEs) per 1000 person years. Suboptimal monitoring was involved in 61% of the preventable adverse drug events. Monitoring problems that were associated with ADEs tended to fall into the categories of monitoring too infrequently or not responding adequately to signs, symptoms, or laboratory test indications of drug toxicity.

Integrated technologies are primarily medication management devices with add-on health management features. While these integrated technologies allow for more comprehensive health management, they can be more expensive and complicated than their standalone counterparts, making them more difficult to use.

Because of these issues and others, it is imperative that today's technology provide appropriate clear directions on when a particular medication is needed and how it is to be taken (e.g. with food and/or water). Hence there is a need for portable home medication reminders, medication dispensers and devices that combine informing and dispensing functions that can help patients manage their medications and reduce the risk that a patient will miss taking his medication in the home or while traveling. Moreover, home medication management systems that provide guidance and maintain the integrity of the original packaging will limit the potential for a user to take a prescribed medication inadvertently, which may increase the possibility of adverse effects caused by such a medication.

### BRIEF SUMMARY OF THE INVENTION

In this regard, the present invention provides a method and system for monitoring compliance with medication regimens. More specifically, the present invention provides a method and system that is implemented with pre-packaged medication systems for the tracking and monitoring of when, where and by whom the medication was taken. Still further, the present invention provides a system for integration onto the back or side of a medication dispensing package for monitoring and compliance tracking of medication regimens. The goal is to couple existing automated pharmacy multi-dose packaging with new monitoring technologies in an attempt to lower the cost of the technology, provide real-time connectivity to the home, simplify the user experience, and provide better health management.

A variety of prepackaged medication dispensing systems are known in the art. Typically they are customized, prepackaged rolls of medications that have been packaged in sealed pouches in groups corresponding to the day and time at which the patient should take the medication. The medications are enclosed in a pouch that typically has a clear side so that the medication contained therein can be seen and identified while the other side of the pouch is translucent white so that indicia can be printed thereon to identify the date, time and dosing of the medication contained therein. Such systems are known in the art and need no further description herein. The present invention provides for an add-on device that sits piggyback on, or in a stand adjacent, the dispensing box to facilitate reliable tracking of the medication regimen compliance.

In general, the system includes a camera that is web enabled to upload photo and/or video content to a cloud based tracking database for analysis, tracking and further processing as desired. The camera itself begins streaming upon detection of motion proximate the medication box. When a user approaches the medication box, the camera preferably captures an image of the pill package being dispensed and an image of the face of the person removing the pill package. This information is streamed to an algorithm/database housed in the cloud wherein the data is processed using predetermined rule sets. The rule sets may include, but are not limited to, a determination that the correct person took the medication via a facial recognition process, the time and day the medication was taken, the package dispense, etc.

To identify the meds taken, the algorithm may read the text on the package via an OCR algorithm. Similarly the packs may include indexing or machine readable codes to identify to the clouds system the types and doses of medication taken.

The cloud system then may employ a variety of rules like noting that the wrong person took a controlled narcotic for example or that the user has taken too many doses or has not taken their prescribed dose at the proper time. As one skilled in the art should appreciate such rules are exemplary and not meant to be limiting.

The system of the present invention is also preferably enabled with a speaker and microphone to facilitate one and/or two way communication. In such an arrangement the system can issue audible reminders or alarms. Further, the system can allow other useful features such as two-way communication to place a live interactive call to a pharmacist or pharmacy call center. This allows interactive refill ordering and allows a user to get questions regarding their medications answered. It also allows the introduction of emergency contacts such as sending reminders to others should a dose of medication not be taken or the placement of an emergency or 911 call should the situation warrant.

In still a further embodiment the present invention is developed to be interactive in local communication networks. This allows the functionality of controlling lights to flash them as a reminder to take medications. Further this allows interactivity with devices such as other home health care devices including but not limited to scales, pulse oximeters, blood pressure, etc. for gathering and transmitting relevant health information to healthcare providers via a single portal/point of contact system.

It is therefore and object of the present invention to provide a portable home medication reminder, medication dispenser and device that combines informing and dispensing functions that can help patients manage their medications and reduce the risk that a patient will miss taking his medication in the home or while traveling. Moreover, it is an object of the present invention to provide a home medication management system that provides guidance and maintains the integrity of the original packaging that will in turn limit the potential for a user to take a prescribed medication inadvertently, which may increase the possibility of adverse effects caused by such a medication.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of a method and system for monitoring compliance with medication regimen in accordance with the present invention;

FIG. 2 is a rear perspective view of a method and system for monitoring compliance with medication regimen in accordance with the present invention;

FIG. 3 is a view of a method and system for monitoring compliance with medication regimen in accordance with the present invention being removed from the medication box; and

FIG. 4 is a side perspective view of a method and system for monitoring compliance with medication regimen in accordance with the present invention.

### DETAILED DESCRIPTION OF THE INVENTION

Now referring to the drawings, a method and system for monitoring compliance with medication regimen is shown and generally illustrated in the figures. As can be seen the principal components of the system include a prepackaged medication box having a strip of blister packaged medications therein and a monitoring device releasably mounted to a surface of the medication box in a manner that the camera on the monitoring device has a clear, unobstructed view of the medication blister package being dispensed.

In this regard, the present invention provides a method and system for monitoring compliance with medication regimens. More specifically, the present invention provides a method and system that is implemented with pre-packaged medication systems for the tracking and monitoring of when, where and by whom the medication was taken. Still further, the present invention provides a system for integration onto the back or side of a medication dispensing package for monitoring and compliance tracking of medication regimens. The goal is to couple existing automated pharmacy multi-dose packaging with new monitoring technologies in an attempt to lower the cost of the technology, provide real-time connectivity to the home, simplify the user experience, and provide better health management.

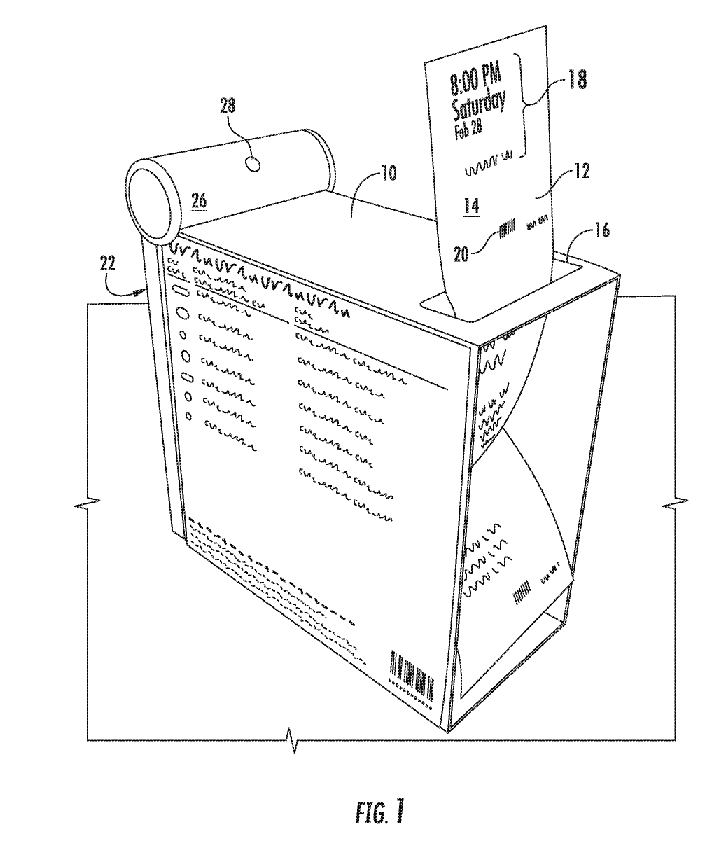

Turning now to FIG. 1, a variety of prepackaged medication dispensing systems are known in the art. Such a dispensing system for example is typically provided as a box 10 that contains a roll of prepackaged medications 12, wherein the medications are packaged in sealed pouches 14 in groups corresponding to the day and time at which the patient should take the medication. The medications are enclosed in a pouch 14 that typically has a clear side so that the medication contained therein can be seen and identified while the other side of the pouch is translucent white so that indicia can be printed thereon to identify the date, time and dosing of the medication contained therein. The roll containing the medications 12 for a predetermined date range are prepared by a pharmaceutical dispensary and placed into a box 10 or the like for the patient's convenience. The top of the box 10 includes a dispenser opening 16 out of which the leading end of the roll of prepackaged medications extends. In operation, a user takes the first pouch 14 in the prepackaged roll 12, tears the pouch 14 from the roll 12 and takes the medications contained in the pouch, leaving the next pouch ready and available for the next appointed time.

Each pouch 14 can be seen to bear indicia 18 on one side thereof that includes at least the date and time at which the medication contained in the pouch 14 is to be taken as well as the dosage and type of medications contained therein. Further, there may be other machine readable code 20 thereon as will be described in more detail below. As can be further seen in FIG. 2, the pouches may also include information or machine readable code 20 on the reverse side thereof as well.

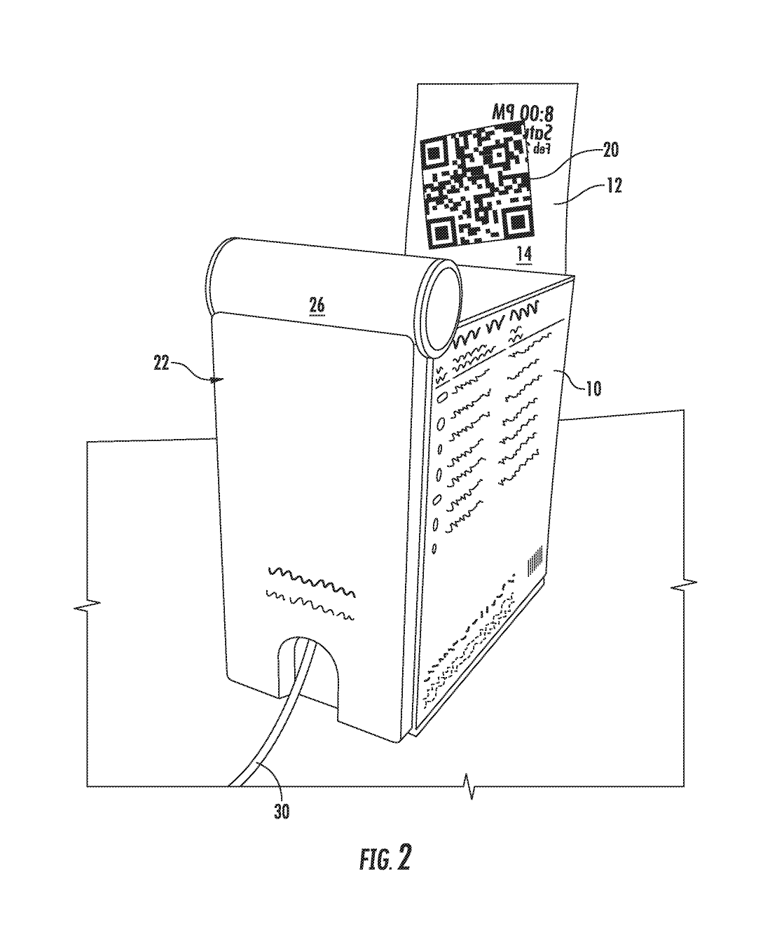

Viewing FIGS. 1-4, the present invention provides a monitoring and compliance reporting device 22 that operates in conjunction with the box 10 containing the prepackaged medications. In operation, the monitoring device 22 can be attached to the box 10, placed piggyback on the box 10 or may be positioned in a stand adjacent to the dispensing box to facilitate reliable tracking of the medication regimen compliance. As can be seen in FIG. 3, the monitoring device 22 may also include a tab 24 that extends over an edge of the box container to allow the monitoring device to be supported directly on the box itself.

In general, the system includes a housing 26 that encloses at least a camera 28 and a network interface. The housing 26 includes a cable 30 extending therefrom that allows the monitoring device 22 to be interfaced with a computer, a power supply or the like. Further, the housing 26 can optionally include a network communication device that allows the device to communicate with a global computer network via any known communication protocol such as WIFI, cellular, Bluetooth® and the like. Should the system utilize wireless communications in lieu of interfacing with a computer, then the cable instead simply provides a means for powering the device via a charging block connection as is well known in the art.

The monitoring device 22 is configured to communicate via a global computer network in that it is web enabled to upload photo and/or video content to a cloud based tracking database for analysis, tracking and further processing as desired. The camera 28 itself begins streaming upon detection of motion proximate the medication box. When a user approaches the medication box, the camera 28 preferably captures an image of the medication pouch 14 being dispensed and an image of the face of the person removing the medication pouch 14. Further, the actual date and time at which the image is captured is registered with the image itself. The image and the related information are streamed to an algorithm/database housed in the cloud wherein the data is processed using predetermined rule sets.

In operation the rule sets minimally log the date and time that each particular medication pouch 14 is removed from the storage box 10. Further, by applying known facial recognition algorithms to the captured image, the system can make a determination that the correct person took the medication. Rules may also include, but are not limited to, facial recognition, time logging, date logging, pouch dispensing rate and number, a non-dispensing event after a predetermined grace period, permitted user recordings, reminder generation, etc.

To identify the medication pouch 14 that was taken, the camera 28 can capture an image of the indicia 18 on the pouch, the machine readable code 20 on the pouch or a combination thereof. The image, when forwarded to the web based algorithm, may read the text on the pouch via an OCR algorithm. Similarly the algorithm may process the indexing or machine readable codes captured in the image to identify to the web based system the types and doses of medication taken.

The web based system then may employ a variety of additional rules like noting that the wrong person took a controlled narcotic for example or that the user has taken too many doses or has not taken their prescribed dose at the proper time. As one skilled in the art should appreciate such rules are exemplary and not meant to be limiting.

The system of the present invention also preferably includes a speaker and microphone within the housing 26 to facilitate one and/or two way communication between the user and the system and/or live system monitors. In such an arrangement the system can issue audible reminders or alarms to the user that it is time that a medication pouch be removed and taken or that a medication pouch remains in the box following a predetermined grace period. Further, the system can allow other useful features such as two-way communication to place a live interactive call to a pharmacist or pharmacy call center. This allows interactive refill ordering and allows a user to get questions regarding their medications answered. It also allows the introduction of emergency contacts such as sending reminders to others via text message, email or telephone, should a dose of medication not be taken or the placement of an emergency or 911 call should the situation warrant.

In still a further embodiment the present invention is developed to be interactive in local communication networks. This allows the functionality of controlling lights to flash them as a reminder to take medications. Further, this allows interactivity with devices such as other home health care devices including but not limited to scales, pulse oximeters, blood pressure, etc. for gathering and transmitting relevant health information to healthcare providers via a single portal/point of contact system.

Accordingly, embodiments of the invention include a device for monitoring compliance with a medication regimen, comprising: a housing configured and arranged for placement proximate a medication dispensing box that contains a plurality of prepackaged medication pouches; a camera positioned within the housing positioned to capture an image when one of the medication pouches is removed from the dispensing box; and a communication interface within the housing that transmits the captured image to a cloud based repository via an electronic communication network.

The captured image is either photographic or video. The captured image may further include an image of both the medication pouch being removed and a user removing the medication pouch. A time and date corresponding to the capture of said image is logged and/or transmitted with said image to a cloud based repository via an electronic communication network.

In a further embodiment, an algorithm at the cloud based repository identifies which one of the plurality of prepackaged medication pouches was removed. Identification of the pouch may be made using OCR, machine readable code or a combination thereof. The algorithm at the cloud based repository may further verify that the removed medication pouch was removed by the correct user. Identification of the user that removes one of the plurality of prepackaged medication pouches may be made using facial recognition.

The system may further include a speaker for audio alerts and messages. In this way, the monitoring algorithm operating at the cloud based repository can directly generate reminders in the event that a pouch was not removed when scheduled or if a pouch was removed at an unscheduled time or generate reminders to others via text message, email or telephone in the event that a pouch was not removed when scheduled or if a pouch was removed at an unscheduled time.

It can therefore be seen that the present invention to provides a portable home medication reminder, medication dispenser and device that combines informing and dispensing functions that can help patients manage their medications and reduce the risk that a patient will miss taking his medication in the home or while traveling. Moreover, the present invention provides a home medication management system that provides guidance and maintains the integrity of the original packaging that will in turn limit the potential for a user to take a prescribed medication inadvertently, which may increase the possibility of adverse effects caused by such a medication. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A device for monitoring compliance with a medication regimen, comprising:
a housing configured and arranged for placement proximate a medication dispensing box, said medication dispensing box containing a plurality of prepackaged medication pouches;
a camera positioned within said housing, said camera positioned to capture an image when one of said medication pouches is removed from said dispensing box; and
a communication interface within said housing that transmits said captured image to a cloud based repository via an electronic communication network.

2. The device of claim 1, wherein said captured image is either photographic or video.

3. The device of claim 1, wherein said captured image includes an image of both the medication pouch being removed and a user removing the medication pouch.

4. The device of claim 1, wherein a time and date corresponding to the capture of said image is logged.

5. The device of claim 4, wherein a time and date corresponding to the capture of said image is transmitted with said image to a cloud based repository via an electronic communication network.

6. The device of claim 1, wherein an algorithm at the cloud based repository identifies which one of said plurality of prepackaged medication pouches was removed.

7. The device of claim 6, wherein said algorithm identifies which one of said plurality of prepackaged medication pouches was removed using OCR, machine readable code or a combination thereof.

8. The device of claim 1, wherein an algorithm at the cloud based repository verifies that said removed medication pouch was removed by the correct user.

9. The device of claim 8, wherein said algorithm identifies a user that removes one of said plurality of prepackaged medication pouches using facial recognition.

10. The device of claim 1, further comprising a speaker for audio alerts and messages.

11. The device of claim 1, further comprising:
a monitoring algorithm operating at said cloud based repository that generates reminders in the event that a pouch was not removed when scheduled or if a pouch was removed at an unscheduled time.

12. The device of claim 1, further comprising:
a monitoring algorithm operating at said cloud based repository that generates reminders to others via text message, email or telephone in the event that a pouch was not removed when scheduled or if a pouch was removed at an unscheduled time.

13. A device for monitoring compliance with a medication regimen consisting of a medication dispensing box containing a plurality of prepackaged medication pouches, comprising:
a housing configured and arranged for engagement with said medication dispensing box;
a camera positioned within said housing, said camera positioned to capture an image when one of said medication pouches is removed from said dispensing box; and
a communication interface within said housing that transmits said captured image to a cloud based repository via an electronic communication network.

14. The device of claim 13, wherein said captured image includes an image of both the medication pouch being removed and a user removing the medication pouch.

15. The device of claim 13, wherein a time and date corresponding to the capture of said image is logged and/or transmitted with said image to a cloud based repository via an electronic communication network

16. The device of claim 13, wherein an algorithm at the cloud based repository identifies which one of said plurality of prepackaged medication pouches was removed using OCR, machine readable code or a combination thereof.

17. The device of claim 13, wherein an algorithm at the cloud based repository identifies a user that removes one of said plurality of prepackaged medication pouches using facial recognition and verifies that said removed medication pouch was removed by the correct user.
